(19) United States
(12) Patent Application Publication
(10) Pub. No.: US 2026/0077964 A1
(43) Pub. Date: Mar. 19, 2026

(54) METHOD AND DEVICE FOR MONITORING THE OPERATION OF A TRANSPORT DEVICE

(71) Applicant: B&R Industrial Automation GmbH, Eggelsberg (AT)

(72) Inventors: Andreas Weber, Eggelsberg (AT); Stefan Brucker, Eggelsberg (AT)

(21) Appl. No.: 18/861,709

(22) PCT Filed: Apr. 28, 2023
(86) PCT No.: PCT/EP2023/061219

§ 371 Date: Sep. 30, 2025

(30) Foreign Application Priority Data
May 2, 2022 (AT) A 50297/2022

(51) Int. Cl. B65G 54/02; B65G 43/00; H02P 6/00

(52) U.S. Cl. CPC B65G 54/02; B65G 43/00; H02P 6/006; B65G 2203/0291

(57) ABSTRACT

The disclosure relates to a method and a device for monitoring the operation of a transport device in the form of a stator linear motor having a transport section along which a multiplicity of drive coils are arranged. At least one transport unit is moved along the transport section, wherein drive magnets of the transport unit interact with the drive coils to produce a propulsion force. At least one drive coil is selected as a measurement coil. While the transport unit is moving over the measurement coil, a control unit predefines a variable for the measurement coil in such a way that the present coil current in the measurement coil is regulated. A unit records a time characteristic of the variable while the transport unit is moving over the measurement coil, and evaluates the time characteristic by an evaluation unit.

### CROSS-REFERENCE TO RELATED APPLICATIONS

The present application is a national phase entry of International Patent Application No. PCT/EP2023/061219, filed on Apr. 28, 2023, and titled “METHOD AND DEVICE FOR MONITORING THE OPERATION OF A TRANSPORT DEVICE”, which claims priority to Austrian Patent Application No. A50297/2022, filed on May 2, 2022, and titled “METHOD AND DEVICE FOR MONITORING THE OPERATION OF A TRANSPORT DEVICE”, which are hereby incorporated by reference in their entirety.

### TECHNICAL FIELD

The present disclosure relates in general to the field of plant manufacturing, in particular to the area of automation technology. The present disclosure specifically relates to a method for monitoring the operation of a transport device in the form of a long stator linear motor having a transport track along which a plurality of drive coils is arranged. In this case, at least one transport unit is moved along the transport track, wherein drive magnets of the transport unit interact with the drive coils of the transport track to produce a propulsive force. The present disclosure furthermore relates to an apparatus for monitoring the operation of a transport device in the form of a long stator linear motor.

### BACKGROUND

Nowadays, in most modern production plants, it is necessary to move parts or components between the individual handling or production stations-sometimes even over relatively long transport tracks-using transport devices. Different transport and conveying devices can be used for this transport, such as continuous conveyors or conveyor belts in various embodiments, for example, in which a rotational movement of an electric drive is converted to a linear movement. However, flexibility is significantly restricted by such continuous conveyors; in particular, individual transport of single transport units is not possible.

So-called long stator linear motors or LLM for short are increasingly being used in transport devices to meet the requirements of modern and flexible transport devices. In this case, long stator linear motors are expressly understood to be linear long stator linear motors with movements in a movement direction and planar long stator linear motors with movements in a movement plane, which are often also referred to as planar motors.

In a linear long stator linear motor, for example, a plurality of electric drive coils, which form the stator, are arranged next to one another along a transport track or movement track, usually in a stationary manner. A number of drive magnets are arranged on a transport unit. The drive magnets can be in the form of either permanent magnets or electric coils or short-circuit windings. The drive magnets of the transport unit produce a magnetic excitation field, which interacts with an electromagnetic field of the drive coils of the stator. Appropriate actuation of the individual drive coils in the region of the transport unit to control the magnetic flux produces a propulsive force on the transport unit or influences a variable of the propulsive force to move the transport unit along the transport track in a desired manner. In the case of a linear long stator linear motor, it is also possible to arrange many transport units along the transport track, the movements of which transport units can be controlled individually and independently of each other by energizing the drive coils interacting with a respective transport unit-usually by applying an electrical voltage. Examples of linear long stator linear motors are known, for example, from WO 2013/143783 A1, U.S. Pat. No. 6,876,107 B2, US 2013/0074724 A1 or WO 2004/103792 A1.

Planar motors can also be used in transport devices, for example, to implement very flexible transport processes with complex movement profiles. When a planar motor is used in a transport device, a plurality of electric drive coils, which form the stator, are arranged in a movement plane, for example. The drive coils arranged in the movement plane produce a magnetic field, which can be moved in two dimensions (for example xy plane) in the movement plane. The drive magnets arranged on the transport unit can also be arranged in a manner distributed two-dimensionally to interact with the magnetic field of the drive coils and to move the transport unit in the transport planes on a movement track or transport track that can be predetermined by the magnetic field. By arranging the drive coils in the movement plane and the drive magnets on the respective transport unit accordingly, it is possible to achieve more complex two-dimensional movements in the transport plane as the movement track or transport track of the transport unit, in addition, for example, to a one-dimensional movement in the transport plane (for example along the axes spanned by the transport plane—for example x and y axis in an xy plane). The functionality and the structure of planar motors is known in principle and can be gathered, for example, from document U.S. Pat. No. 9,202,719 B2 or document WO 2021/105155 A1.

Long stator linear motors may be in the form of synchronous machines, both self-excited or externally excited, or asynchronous machines. A long stator linear motor is characterized, in particular, by a better and more flexible utilization over the entire operating range of the movement (position, speed, acceleration). Furthermore, closed-loop/open-loop control of the transport units along the transport track or movement track is carried out individually. Long stator linear motors also exhibit an improved energy utilization, reduced maintenance costs due to the lower number of worn parts, simple replacement of the transport units, efficient monitoring and fault detection, and optimization of the product stream along the transport track or movement track.

A long stator linear motor places high demands on the control of the movement of the transport units. A plurality of controllers is usually provided for this purpose, these controllers controlling the energization of the drive coils to move the transport units as intended along the transport track or movement track. Interaction of the drive magnets of the transport unit with the drive coils, which predetermine the transport track, is particularly important for the movement of the respective transport unit in a long stator linear motor-both in a linear long stator linear motor and in a planar motor. In this case, the drive coils and the transport unit are separated from one another by a gap—a so-called air gap. The drive magnets of the transport unit and the drive coils of the transport track are magnetic voltage sources. In addition to the magnetic voltage, the interaction between the transport unit and the transport track is also determined by a magnetic resistance, which is decisively determined by the air gap or, in particular, by the size of the gap and by the magnetic permeability of the air in the gap. The level of the magnetic voltages produced by the magnetic voltage sources and the magnitude of the magnetic resistance directly determine the electromagnetic properties of the long stator linear motor. In some embodiments, the size of the air gap is generally fixed by the design of a long stator linear motor, for example by the structural design of the long stator linear motor, and is not changed during operation. The magnetic permeability of the air in the air gap is a constant physical variable. The magnetic voltage of the drive magnets is usually fixed, because they are generally in the form of permanent magnets, and does not change during the operation of the transport device. The magnetic voltage of the drive coils is defined by the electrical voltage applied to the drive coils, the level of said voltage usually being determined by the control unit of the transport device.

However, even small changes in the magnetic variables in the interaction between the drive magnets of the transport unit and the drive coils of the transport track, e.g., a change in the magnetic resistance due to change in the size of the air gap, for example, due to states of wear, different loading of transport units, incorrect guidance of a transport unit, magnet withdrawals or assembly errors in the transport unit and/or the transport track, etc., have an effect on the operation of the transport device in the form of a long stator linear motor. Especially, in case of transport devices consisting of multiple transport segments with transfer positions, for example in the form of track switches, for complex and flexible transport track planning and implementation, changes in the size of the air gap may lead, for example, to malfunctions, especially at the transfer positions.

To ensure reliable operation of transport devices and, for example, to prevent movements that pose a safety risk, an open-loop control system for an electric motor, in particular for a linear motor, is known, for example from document DE 10 2015 102 236 A1, which comprises a position capturing device for capturing the positions of the transport units along the stator and a coil monitoring device, which produces coil data representing the status of one or more drive coils of the stator. A safety device is also provided, which compares the position and coil data and transfers the motor to secure operation, if errors are detected in the data comparison. Although said open-loop control system can be used to identify errors or malfunctions, such as deviating positions of transport units, for example, changes in the magnetic variables in the interaction between the drive magnets of the transport unit are not identified by the open-loop control system.

Document WO 2019/238276 A1 discloses a method for monitoring wear of a long stator linear motor and an associated apparatus. Here, during operation of the long stator linear motor, a measuring device is used to measure, for example, a force or a differential force exerted by the transport unit on a stator of a power train or on the transport track, such as, for example, a tensile force between a frame and the stator of the transport device or a compressive force by guide units (for example rollers) of the transport units on guide rails. The measured force or differential force is then compared with a permissible maximum value to be able to draw conclusions about a size of the air gap between the stator and the transport unit, particularly a magnet unit on the transport unit. However, this type of wear monitoring has the disadvantage that sensors (for example measuring sensors) additionally must be arranged on the long stator linear motor for wear monitoring, wherein the accuracy, with which a size of the air gap can be deduced, depends on the installation and measuring accuracy of the sensors.

As an alternative, document WO 2019/238276 A1 also discloses a method, in which a voltage that is induced by the drive magnets in at least one coil winding of the stator of the long stator linear motor, is measured. This voltage is then used to estimate the size of the air gap. For this purpose, values of a nominally induced voltage for different air gap sizes are calculated from position and speed information of the transport unit and from an open-loop control response of the open-loop stator electronics system. These calculated values are then compared with the measured induced voltage to determine an actual size of the air gap. In this embodiment, an additional measuring apparatus is also used, which measures the induced voltage in the coil winding. Furthermore, when the voltage induced in the coil winding is measured, there may be inaccuracies and/or erroneous estimations of the air gap due to disturbance variables (for example resistance and/or inductance of the coil winding), which can usually change continuously during operation of the long stator linear motor.

### BRIEF DESCRIPTION

It is therefore the objective of the present disclosure to provide a method and an apparatus with which it is possible to identify assembly errors, occurrences of wear and/or other malfunctions quickly and with a high degree of accuracy during a test operation and/or running operation of a transport device in the form of a long stator linear motor without great effort.

This objective is achieved by a method and an apparatus for monitoring the operation of a transport device in the form of a long stator linear motor in accordance with the independent claims. Advantageous embodiments of the present disclosure are described in the dependent claims.

According to the present disclosure, the objective is achieved by a method mentioned at the beginning for monitoring the operation of a transport device in the form of a long stator linear motor, in which at least one drive coil, which is arranged together with a plurality of drive coils along the transport track of the transport device, is selected as a measurement coil. Then, while at least one transport unit, which is moved along the transport track, is being moved over the measurement coil, a manipulated variable is specified as an excitation signal to the measurement coil, used as controlled system, in such a way that a respective present coil current in the measurement coil is controlled to a predetermined setpoint value. Furthermore, a time profile of the manipulated variable is captured, while the at least one transport unit is being moved over the measurement coil, and then the captured time profile of the manipulated variable is evaluated to monitor the transport device.

The main aspect of the proposed solution consists in that assembly errors, occurrences of wear and/or other malfunctions can be identified quickly and with a high degree of accuracy in a simple manner, for example during a test operation and/or during running operation. By evaluating the time profile of the manipulated variable, from which a development of the voltage induced in the drive coil that is selected as the measurement coil during a moving-over of the transport unit can be determined, it is possible, for example, to determine a width of an air gap between the drive coils of the transport track and the drive magnets of the transport unit and/or a normal force with which the drive magnets of the transport unit act on the surface of the transport track. Furthermore, it is then possible, for example by comparison with expected values known in advance for the profile of the manipulated variable, to draw conclusions about instances of wear on the transport unit (for example on guide elements etc.), assembly errors in the transport track (for example incorrectly mounted drive coils etc.) and/or the installation of the drive magnets (for example displacement, rotation, detachment, etc.), and these can be discovered very quickly.

In this case, it is advantageous, if a value of zero is specified as the setpoint value to which the respective present coil current in the measurement coil is controlled. If the specified setpoint value is set to zero, it is very easy to determine the development of the voltage that is induced in the drive coil selected as measurement coil while the transport unit is being moved from the captured time profile of the manipulated variable. The captured time profile of the manipulated variable ideally corresponds to the time development of the induced voltage.

It is also advantageous, when a drive controller, which is assigned to the drive coil selected as the measurement coil, is used to specify the manipulated variable as the excitation signal. Hardware of the transport device that is already provided can be used in a very simple manner as a result. The drive controller of the drive coil that is selected as the measurement coil can be extended very easily using software to carry out the method, for example, and thus can be used as the control unit for the method.

In the case of a transport track with two or more transport segments, in each transport segment at least one drive coil of the respective transport segment can be expediently selected as the measurement coil. As a result, appropriate selection of drive coils as measurement coils makes it possible to check individual transport segments of the transport track very easily for assembly errors, for example.

One embodiment of the present disclosure provides that the at least one drive coil of the transport track, which has been selected as the measurement coil, is selected as the measurement coil for a limited time. The drive coil selected as the measurement coil ideally functions as the measurement coil only for a duration of one measurement cycle—i.e., for the duration of one travel of a transport unit. This keeps the use of a drive coil as measurement coil as short as possible. This is quite advantageous, if the coil current is controlled to a specified setpoint value of zero, wherein the drive coil selected as the measurement coil cannot be used for a control process to form a propulsive force during the selection as the measurement coil. However, it is also possible for a drive coil to function as the measurement coil, for example, for two or more measurement cycles and then be used again only as a drive coil. Alternatively, it can also be advantageous, if the at least one drive coil of the transport track is permanently selected as the measurement coil.

It is also advantageous, if an observation period in which the time profile of the manipulated variable is captured is predetermined. The specified observation period may range, for example, from one measurement cycle (i.e., capturing of the manipulated variable while the transport unit moves over the measurement coil) over one or more days and one or more months up to an entire lifetime or usage duration of the transport device.

It may also be advantageous, when the time profile of the manipulated variable is captured at cyclically repeating intervals. In this case, the method for monitoring the operation of the transport device can be carried out repeatedly during the observation period, for example multiple times daily, daily, weekly, etc., depending on the application of the transport device in order to be able to identify wear, faults, etc. for example very quickly by comparing the respective captured time profiles of the manipulated variable.

A time profile of a magnetic flux is ideally derived from the captured time profile of the manipulated variable for evaluation. The time profile of the magnetic flux can be derived, for example by integration from the time development of the voltage induced in the measurement coil, which can be derived from the captured time profile of the manipulated variable. By measuring the time profile of the magnetic flux and by comparing it with expected values known in advance for characteristic properties (for example positions of minima, maxima and/or zero crossings, amplitude intervals, etc.) of the profile, it is possible, for example, to obtain information about the drive magnets (for example material, strength, polarity, etc.) of the transport unit. This information can ideally be used, for example, to select the transport units or to identify erroneous changes in the drive magnets (for example detachment of a magnet, displacement of a magnet, etc.) during running operation.

It is also advantageous, when the captured time profile of the manipulated variable is normalized to a nominal speed of the at least one transport unit. As a result, for example, captured time profiles can be compared more easily when, for example, changes (for example wear etc.) on the transport unit and/or transport track are to be identified through cyclic repetition of the method.

Said objective is also achieved by an apparatus for monitoring the operation of a transport device in the form of a long stator linear motor having a transport track along which a plurality of drive coils is arranged. The transport device further comprises at least one transport unit which can be moved along the transport track, wherein drive magnets of the at least one transport unit interact with the drive coils of the transport track to produce a propulsive force. In this case, said apparatus comprises at least a measurement coil which can be selected from the plurality of drive coils arranged along the transport track, and a control unit which is configured to predetermine a manipulated variable as an excitation signal to the measurement coil such that the respective present coil current in the measurement coil is controlled to a specified setpoint value. The apparatus further comprises a unit for capturing a time profile of the manipulated variable and a unit for evaluating the captured time profile of the manipulated variable.

By way of example, a separate controller can be used as the control unit. However, a drive controller, which is assigned to the drive coil that is selected as the measurement coil, can ideally be used as the control unit. This easily prevents a further or additional hardware unit having to be provided or installed in the transport device.

To ideally further reduce hardware outlay, the unit for capturing the time profile of the manipulated variable can also be integrated into the control unit—in particular, into the drive controller of the drive coil that is selected as the measurement coil. The coil current in the measurement coil is thus controlled to the specified setpoint value by the control unit without additional equipment and the time profile of the manipulated variable is also captured during control for evaluation.

It is also advantageous, when the unit for evaluating the time profile of the manipulated variable is configured to derive a time profile of a magnetic flux from the captured profile of the manipulated variable. Ideally, a time profile of the voltage induced in the drive coil being selected as the measurement coil can be determined from the captured time profile of the manipulated variable by the unit for capturing the time profile of the manipulated variable or by the unit for evaluating the time profile of the manipulated variable.

### BRIEF DESCRIPTION OF DRAWINGS

The present disclosure is explained in more detail below with reference to FIGS. 1 to 5a and 5b, respectively, which show advantageous configurations of the present disclosure by way of example, schematically and in a non-restrictive manner. In the drawings

FIG. 1 shows a configuration of a transport device in the form of a long stator linear motor,

FIG. 2 shows a detailed view of the design of a transport segment and a transport unit,

FIG. 3 shows an embodiment of the method for monitoring the operation of a transport device with an associated apparatus,

FIG. 4 shows a simplified equivalent circuit diagram of the measurement coil,

FIG. 5a shows a time profile of a captured manipulated variable as a function of a position of the transport unit,

FIG. 5b shows a time profile of a magnetic flux as a function of a position of the transport unit.

### DETAILED DESCRIPTION

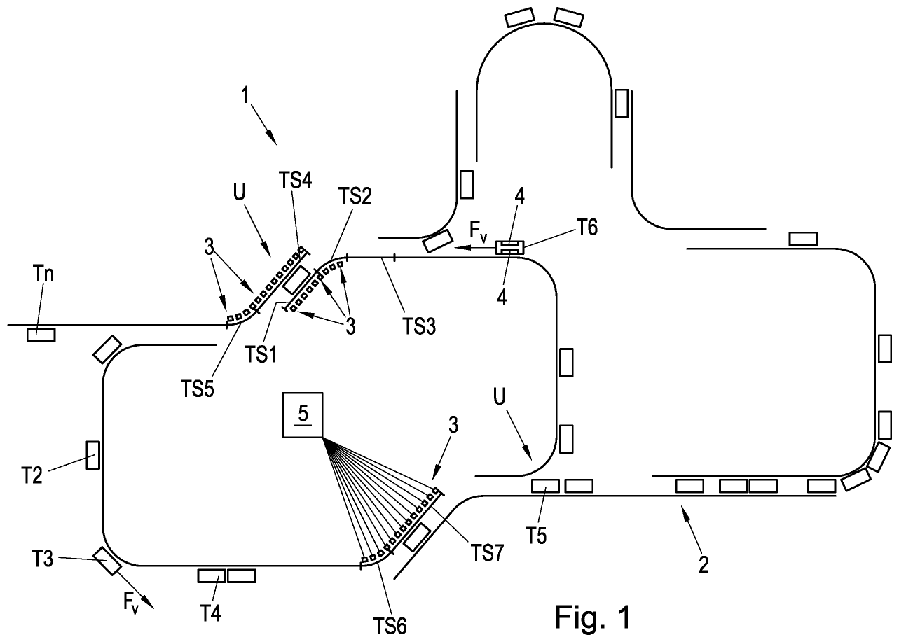

FIG. 1 shows by way of example a transport device 1 in the form of a long stator linear motor, for example a linear long stator linear motor. The transport device 1 consists of several transport segments TSk (k≥1 is in this case an index standing for all present transport segments TS1, TS2, TS3, . . . , TS7), of which only the transport segments TS1, . . . , TS7 are exemplary shown for reasons of clarity. One transport segment TSk is arranged on each side of the transport track 2—for example on a supporting structure, which is not shown. The transport segments TSk form different section portions of the transport track 2, for example straight lines, curves with different angles and radii, separators, etc. and can be combined very flexibly to form the transport track 2.

The transport segments TSk together form the usually stationary transport track 2 along which the transport units Tn can be moved (n≥1 is in this case an index standing for all present transport units T1, T2, T3, T4, . . . , wherein not all the transport units Tn in FIG. 1 are denoted by reference signs for reasons of clarity). Because of a modular design of this kind, the transport device 1 or the transport track 2 can be configured very flexibly, but also requires a plurality of delivery positions U, such as separators etc., for example, at which the transport units Tn that are moved on the transport device 1 are delivered from one transport segment TSk to another.

The transport device 1 is in the form of a long stator linear motor, in which the transport segments TSk form a respective part of a long stator of the long stator linear motor in a manner known per se. Therefore, a plurality of electric drive coils 3, which form the stator and are arranged in a stationary manner, are arranged along the transport segments TSk in the longitudinal direction in a known manner (indicated only for the transport segments TS1, TS2, TS4, TS5, TS6, TS7 in FIG. 1 for reasons of clarity).

The drive coils 3 can interact with drive magnets 4 on the transport units T1, . . . , Tn (indicated only for transport unit T6 in FIG. 1 for reasons of clarity) to produce a propulsive force Fv. The drive coils 3 are actuated in a well-known manner by a control unit or a drive controller 5 (only indicated in FIG. 1) to apply the coil voltages required for the desired movement of the transport units Tn.

There may also be section portions, such as transfer positions U etc., for example, along the transport track 2, at which transport segments TSk are arranged on both sides, between which a transport unit Tn is moved (for example the transport segments TS1, TS4). If the transport unit Tn is equipped with drive magnets 4 on both sides (as seen in the direction of movement), then the transport unit Tn may also interact simultaneously with the transport segments TSk arranged on both sides or with the drive coils 3 thereof. A greater propulsive force Fv in total can thus of course also be generated.

A transport device 1 in the form of a planar motor has a transport plane as the transport region, in which a plurality of drive coils 3 are arranged. The drive coils 3 are actuated in normal operation for example in a well-known manner by a control unit or a drive controller 5 to produce a magnetic field in the transport plane and to move the transport units Tn in the transport plane, for example, along a desired movement track. Through appropriate actuation of the drive coils 3, one or more transport units Tn can also be moved, for example, along more complex movement tracks, which are not necessarily only in parallel with one of the axes of the transport plane of the planar motor. Furthermore, in a transport device 1 in the form of a planar motor, the transport plane may be shaped as desired or be guided in space as desired depending on the application and requirement. The transport plane and thus the possible movement tracks or transport tracks 2 of the transport units Tn often consist of multiple transport segments TSk arranged on one another.

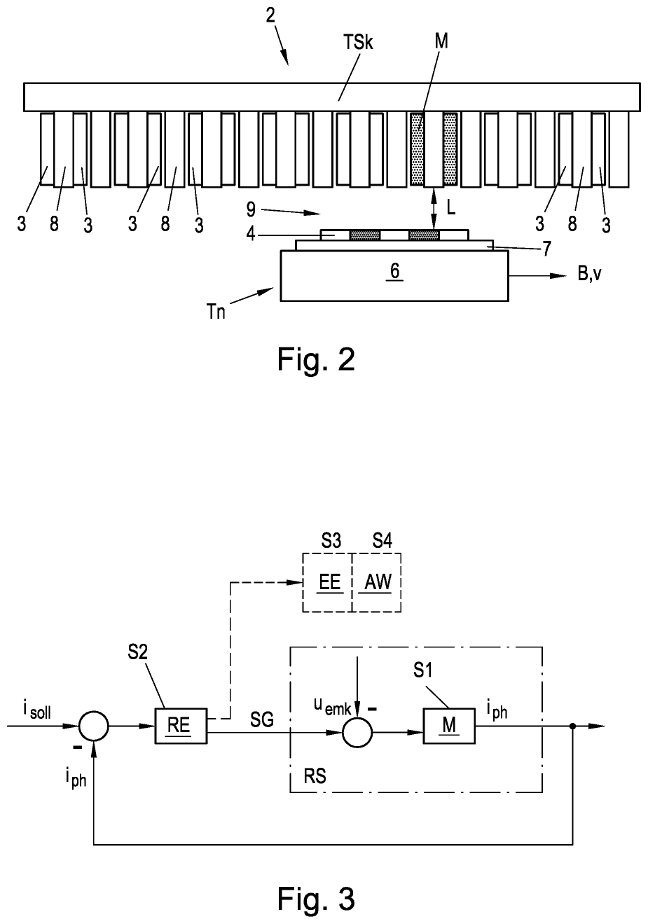

FIG. 2 shows in detail a design of an exemplary transport segment TSk of the transport track 2 and an exemplary transport unit Tn which moves along the transport segment TSk. By way of example, the transport unit Tn has a main body 6, to which a carrier plate or magnetic plate 7 is attached. The drive magnets 4 are arranged on the magnetic plate 7, for example. A drive magnet 4 may be designed as electromagnet (excitation coils) and/or as permanent magnet. In the transport unit Tn, shown as example in FIG. 2, the drive magnets 4 are designed as permanent magnets, for example, and are arranged on the magnetic plate 7 with alternating polarity, for example.

In a transport unit Tn designed for use on a linear long stator linear motor, guide elements, such as rollers, wheels, sliding surfaces, guide magnets, etc., can of course also be provided on the transport unit Tn to guide the transport unit Tn along the transport track 2 and to hold the transport unit Tn on the transport track 2, in particular in the event of a stoppage. The guide elements of the transport unit Tn interact with the transport track 2 or the transport segments TSk for guiding, for example by virtue of the guide elements being supported on, hooked into, sliding or rolling off, etc. the transport track 2.

The drive coils 3 are arranged along the transport segment TSk—in some embodiments on teeth 8 of a ferromagnetic core (for example an iron laminated core). However, the drive coils 3 may of course also be formed without a core. The drive magnets 4 of the transport unit Tn produce a magnetic excitation field, which interacts with the electromagnetic field of the drive coils 3 of the transport segment TSk. Appropriate energization of the individual drive coils 3 in the region of the transport unit Tn produces the propulsive force Fv or influences the magnitude thereof. As a result, the transport unit Tn is moved along the transport segment TSk or along the transport track 2 in a desired movement direction B at a speed v. An air gap 9 with an air gap width or size L is formed between the drive coils 3 of the transport segment TSk and the drive magnets 4 of the transport unit Tn.

To monitor the operation of the transport device 1, at least one of the drive coils 3, which is used as the measurement coil M for the monitoring, can be selected in a selection step S1. In transport devices 1 having at least two or more transport segments TSk, at least one drive coil 3 can be defined as the measurement coil M in each transport segment TSk, for example. As an alternative, it is also possible to select at least one drive coil 3, which then functions as the measurement coil M, only in selected transport segments TSk, which are to be checked or monitored during operation of the transport device 1, for example. Furthermore, it is also possible to select or to use multiple drive coils 3 as measurement coils M simultaneously in one transport segment TSk, wherein the drive coils 3 selected as measurement coils M should be physically separated from one another.

In general, a drive coil 3 selected as the measurement coil M functions as the measurement coil M only for a limited time, for example for one measurement cycle or for one moving-over of a transport unit Tn. The measurement coil M is then used again only as a drive coil 3. However, it is also possible that at least one drive coil 3 is selected as the measurement coil M, for example, for two or more measurement cycles or moving-overs of transport units Tn or permanently.

FIG. 3 shows by way of example and schematically an apparatus for monitoring the operation of the transport device 1 and an exemplary procedure of a method for monitoring the operation of the transport device 1. The apparatus comprises at least a control unit RE, a measurement coil M, which forms a controlled system RS, a unit EE for capturing a time profile of a manipulated variable SG, which is output by the control unit RE, and an evaluation unit AW for evaluating the captured time profile of the manipulated variable SG.

To monitor the transport device 1, for example during running operation of the transport device 1 or during a test phase of the transport device 1, at least one drive coil 3, which functions as the measurement coil M for monitoring the transport device 1, is selected in the selection step S1, as already shown in FIG. 2. In general, the drive coil 3 is selected as the measurement coil M only for the duration of one measurement cycle—i.e., for the duration, for example, of one run through the method for monitoring the transport device 1 or the duration of one moving-over of a transport unit Tn. For a further or following measurement cycles, for example, at least one other drive coil 3 of the transport track 2 or of a respective transport segment TSk can be used as the measurement coil M. As an alternative, however, at least one drive coil 3 of the transport unit 1 or of a transport segment TSk can also be determined as the measurement coil M for two or more measurement cycles or permanently.

While the transport unit Tn is moving or traveling over the measurement coil M, in a control step S2, a manipulated variable SG, for example an actuating voltage uₚₕ, is specified as an excitation signal to the measurement coil M as controlled system RS. The predetermination of the manipulated variable SG results in a control current and the respective present coil current iₚₕ is controlled to a predetermined setpoint value iₛₒₗₗ. To this end, the present coil current iₚₕ in the measurement coil M is determined and is coupled back to an input of the control unit RE. The presently determined coil current iₚₕ is compared with the predetermined setpoint value iₛₒₗₗ and the difference between the respective present coil current iₚₕ and the setpoint value iₛₒₗₗ is fed as excitation signal to the control unit RE for determining the manipulated variable SG or the actuating voltage uₚₕ. The control unit RE then specifies or impresses the corresponding manipulated variable SG or the actuating voltage uₚₕ to the measurement coil M. The result is then an appropriate control current, which controls the coil current iₚₕ to the specified setpoint value iₛₒₗₗ. By way of example, a setpoint value of zero can be predefined as the setpoint value iₛₒₗₗ, with the drive coil 3 selected as the measurement coil M then no longer taking part in a control process to form the propulsive force Fv.

When the transport unit Tn is moving over the measurement coil M, the drive magnets 4 of the transport unit Tn move over the measurement coil M, which induces a voltage uₑₘₖ in the measurement coil M due to the drive magnets 4. If, for example, a setpoint value iₛₒₗₗ of zero is specified for the respective present coil current iₚₕ, the respective present coil current iₚₕ can be impressed during the control step S2 or while the transport unit Tn is moving over the measurement coil M only when there is a difference between the voltage uₑₘₖ induced in the measurement coil M and the manipulated variable SG or actuating voltage uₚₕ specified to the measurement coil M as the excitation signal. If the manipulated variable SG or the actuating voltage uₚₕ corresponds to the voltage uₑₘₖ induced in the measurement coil M while the transport unit Tn is moving over, for example, a coil current iₚₕ with the specified setpoint value iₛₒₗₗ of zero flows in the measurement coil M. In other words, it is possible that no coil current iₚₕ flows in the measurement coil M. In the control step S2, the manipulated variable SG is therefore predetermined to the measurement coil M in such a way that the respective present coil current iₚₕ in the measurement coil M is controlled to the specified setpoint value iₛₒₗₗ—for example to the value of zero. The drive coil 3 selected as the measurement coil M can therefore no longer be used for the control to form the propulsive force Fv during its function as measurement coil M, if the setpoint value iₛₒₗₗ is predefined as a value of zero.

If, for example, an arbitrary setpoint value iₛₒₗₗ (i.e., other than zero) is specified for the control of the respective present coil current iₚₕ, a voltage drop across the measurement coil M must be taken into account, for example, said voltage drop being caused by a resistive component Rₚₕ and an inductance Lₚₕ of the measurement coil M and by the coil current iₚₕ. However, the control of the coil current iₚₕ in the measurement coil M to an arbitrary setpoint value iₛₒₗₗ has the advantage that the drive coil 3 selected as the measurement coil M can continue to be used as the drive coil 3 for example in addition to functioning as the measurement coil M—i.e., it takes part in the control to form the propulsive force Fv.

A drive controller 5, which is assigned to the measurement coil M and is already present, can be used as control unit RE, for example. To this end, the drive controller 5 of the measurement coil M can be extended by an appropriate control component, for example. As an alternative, the control unit RE can also be provided as an additional controller RE with an appropriate transfer function.

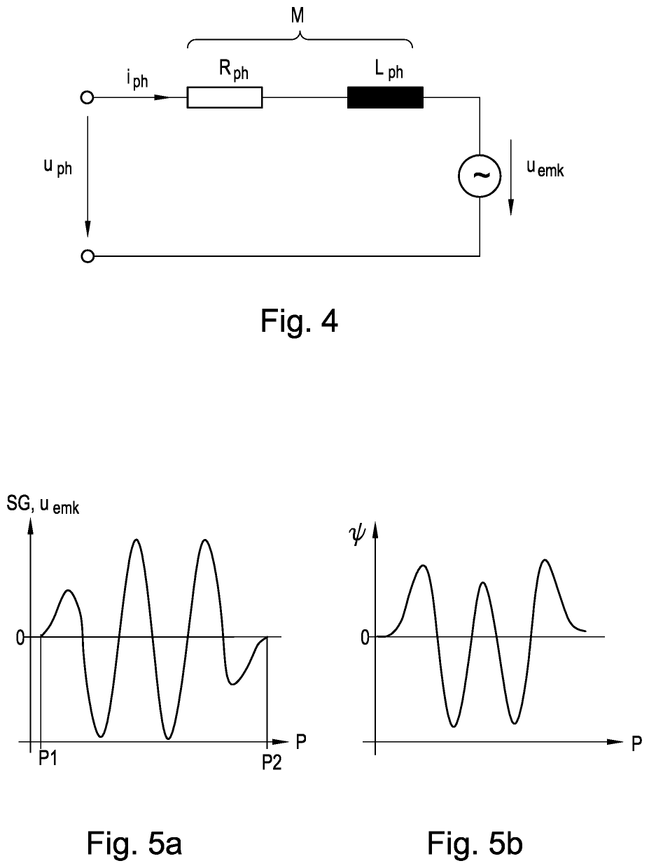

For a layout of the control unit RE that is used to control the coil current iₚₕ to the specified setpoint value iₛₒₗₗ (for example the value of zero) in the measurement coil M while the transport unit Tn is moving over, a simplified equivalent circuit diagram of the measurement coil M can be used, for example. The transfer function of the control unit RE can be derived, for example, from said simplified equivalent circuit diagram, which is shown in FIG. 4.

The equivalent circuit diagram of the measurement coil M comprises, for example, a resistive component Rₚₕ and an inductance Lₚₕ. The movement of the transport unit Tn induces the voltage uₑₘₖ, which is illustrated as a voltage source uₑₘₖ, in the measurement coil M. Furthermore, the actuating voltage uₚₕ, which corresponds to the manipulated variable SG output by the control unit RE, drops between connection terminals of the equivalent circuit diagram. If there is a voltage difference between the induced voltage uₑₘₖ and the actuating voltage uₚₕ, the coil current iₚₕ flows in the measurement coil M, said coil current iₚₕ also causing a voltage drop at the measurement coil M—at the resistive component Rₚₕ and the inductance Lₚₕ. The relationship can be described, for example, as follows:

$${U}_{emk} = {u}_{ph} - {R}_{ph} * {i}_{ph} - {L}_{ph} * ( {di}_{ph} / dt ) .$$

It is clear from this relationship that, to control the coil current iₚₕ to the specified setpoint value iₛₒₗₗ (for example the value of zero), the manipulated variable SG or the actuating voltage uₚₕ corresponds to the voltage uₑₘₖ induced in the measurement coil M—where appropriate, taking into account the voltage drop at the measurement coil M. I.e., for example, if the induced voltage uₑₘₖ and the actuating voltage uₚₕ are equal, no current iₚₕ will flow through the measurement coil M. The transfer function of the control unit RE can thus be derived from the equivalent circuit diagram shown as example in FIG. 4.

For the controlled system RS or the measurement coil M, the following transfer function F(s) thus results, for example, in the so-called Laplace range, based on which the control unit can be designed, for example:

$$F ( s ) = \frac{iph}{uph} = \frac{1}{Rph + s * Lph}$$

Here, F(s) represents a Laplace transform of a function f(t). A given function f(t) in the real time range is transformed into the function F(s) in a complex spectral range (for example frequency range) by the so-called Laplace transformation.

The voltage uₑₘₖ induced in the measurement coil M while the transport unit Tn is moving over may in this case—as shown in FIG. 3—be interpreted as a disturbance variable, for example, which acts at an input of the measurement coil M or the controlled system RS. During the control process, this disturbance variable uₑₘₖ must (additionally) be provided by the control unit RE.

As an alternative, the induced voltage uₑₘₖ or the disturbance variable uₑₘₖ can be compensated for, for example, by a feed-forward control system. To this end, the manipulated variable SG is supplied with expected values for the induced voltage uₑₘₖ, which are estimated, for example, using dynamic, mathematical models on the basis of a speed of the transport units Tn. The optional feed-forward control system, which may be integrated, for example, into the control unit RE, ideally relieves the load on the control unit RE.

In a capturing step S3, a time profile of the manipulated variable SG output by the control unit RE is then captured, as long as the transport unit Tn is being moved over the measurement coil M. The manipulated variable SG in this case corresponds to the actuating voltage uₚₕ, which is specified to the measurement coil M as the excitation signal. The coil current iₚₕ is continuously controlled to the predetermined setpoint value iₛₒₗₗ (for example the value of zero) by the control unit RE while the transport unit Tn is moving over the measurement coil M and the time profile of the manipulated variable SG or the actuating voltage uₚₕ output by the control unit RE is captured. The time profile of the manipulated variable SG can be captured, for example, by the unit EE for capturing the time profile of the manipulated variable SG. Said unit EE can be designed as an independent unit or it can be integrated into the control unit RE, for example.

The time profile or time development of the voltage uₑₘₖ induced in the measurement coil M by the drive magnets 4 of the transport unit Tn can be determined from the captured time profile of the manipulated variable SG or the actuating voltage uₚₕ output by the control unit RE. With a specified setpoint value iₛₒₗₗ of zero, the time profile of the manipulated variable SG or the actuating voltage uₚₕ output by the control unit RE corresponds, for example, to the time development of the voltage uₑₘₖ induced in the measurement coil M by the drive magnets 4 of the transport unit Tn.

With a specified setpoint value iₛₒₗₗ with an arbitrarily selected value or with a value not equal to zero, the voltage drop at the measurement coil M caused by the coil current iₚₕ must be taken into account, for example, to determine the time development of the induced voltage uₑₘₖ from the captured time profile of the manipulated variable SG or the actuating voltage uₚₕ. To this end, for example, drive coils 3 of the transport track 2 can be measured once in advance, wherein, for example, the voltage drop across the at least one drive coil 3 selected as the measurement coil M is determined for the specified setpoint value iₛₒₗₗ by measurement or the voltage drop is modeled for the specified setpoint value iₛₒₗₗ—for example using a model for the coil 3 with, for example, at least one resistive component Rₚₕ and an inductance Lₚₕ.

In an evaluation step S4, the captured time profile of the manipulated variable SG is evaluated to monitor the transport device Tn, wherein the capturing step S3 and the evaluation step S4 may proceed largely in parallel, for example. I.e., in the evaluation step S4, even first values of the manipulated variable SG output by the control unit RE are evaluated, for example, while the transport unit Tn continues to move over the measurement coil M and, in the capturing step S3, further values for the time profile of the manipulated variable SG are captured.

In the evaluation step S4, properties of the drive magnets 4 or the air gap 9, such as the air gap width L, for example, can be concluded, for example, by an evaluation unit AW for evaluating the time profile of the manipulated variable SG from the captured time profile of the manipulated variable SG or from the time development of the induced voltage uₑₘₖ determined therefrom. It is also possible to infer a normal force, which is exerted on a surface of the transport track TSk by the drive magnets 4 of the transport unit Tn, from characteristics (for example minima, maxima, quadratic mean value, etc.) of the development or profile of the induced voltage uₑₘₖ. Evaluation options are explained in more detail below based on FIG. 5a.

A profile of the magnetic flux y responsible for the voltage uₑₘₖ induced in the measurement coil M can also be derived from the captured profile of the manipulated variable SG. The time profile of the magnetic flux y and the evaluation thereof can also be derived in the evaluation step S4 in the evaluation unit AW for evaluating the time profile of the manipulated variable SG. To this end, for example, the profile of the induced voltage uₑₘₖ, which has been determined from the captured profile of the manipulated variable SG, can be integrated. Evaluation options for the time profile of the magnetic flux y are given in more detail below based on FIG. 5b.

Furthermore, the time profile of the manipulated variable SG can be normalized to a nominal speed (for example 1 m/s) of the transport unit Tn in the evaluation step S4, for example, again by the evaluation unit AW for evaluating the time profile of the manipulated variable SG.

FIG. 5a shows by way of example a captured time profile of the manipulated variable SG, wherein the coil current iₚₕ has been controlled to a specified setpoint value iₛₒₗₗ of zero. The time profile of the manipulated variable SG thus also corresponds to the time profile of the voltage uₑₘₖ induced in the measurement coil M while the transport unit Tn is moving over the measurement coil M. Here, a respective position of the transport unit Tn in meters over the selected measurement coil M is plotted on an x axis. The y axis shows an associated value of the manipulated variable SG or the actuating voltage uₚₕ and thus the voltage uₑₘₖ induced in the measurement coil M while the coil current iₚₕ is being controlled to the specified setpoint value iₛₒₗₗ or to the value of zero. The manipulated variable SG or the actuating voltage uₚₕ or the voltage uₑₘₖ induced in the measurement coil M is plotted in volts here. It can be seen from the profile shown in FIG. 5a that a first drive magnet 4 of the transport unit Tn is covered by the measurement coil M for the first time at a first position P1 of the transport unit Tn. At the first position P1, the induced voltage uₑₘₖ and thus the manipulated variable SG begin to increase, because the control unit RE begins to control the coil current iₚₕ to the setpoint value iₛₒₗₗ or to the value of zero from the first position P1. The rest of the profile of the induced voltage uₑₘₖ or the manipulated variable SG shows how they increase and decrease, respectively, and assume positive or negative extreme values depending on how many and which drive magnets 4 of the transport unit Tn with a respective polarity at the respective position, which is assumed by the transport unit Tn due to the movement, interact with the measurement coil M. At a second position P2 of the transport unit Tn, the last drive magnet 4 of the transport unit Tn leaves the area of the measurement coil M. The induced voltage uₑₘₖ or the manipulated variable SG then decreases again to a voltage value of zero.

Properties for the transport device 1, in particular properties of the drive magnets 4 of the respective transport unit Tn, for example during running operation, during a specified observation period or during a test phase, etc. can be derived from the profile of the manipulated variable SG or the voltage uₑₘₖ induced in the measurement coil M, shown as example in figure FIG. 5a. For example, the normal force, with which the drive magnets 4 act on the surface of the transport track 2 or the respective transport segment TSk, can be inferred especially from the characteristics of the captured induced voltage uₑₘₖ, such as minima, maxima, quadratic mean value, etc., for example.

To this end, for example, the profile of the manipulated variable SG or the induced voltage uₑₘₖ can be captured repeatedly using a test transport unit Tn, wherein, for example, the air gap 9 or the size L of the air gap 9 between the drive magnets 4 and the surface of the transport track 2 is adjusted for each capturing of the manipulated variable SG at the transport unit Tn. I.e., multiple profiles of the manipulated variable SG or the induced voltage uₑₘₖ are determined at different air gap widths L. With respect to these profiles, it is then possible to determine, for example, characteristic values such as minima, maxima, quadratic mean values, in the evaluation step S4. If the test transport unit Tn is also measured with respect to the normal force one time in advance using an external measurement system, it is possible to determine a characteristic curve for the normal force as a function of the characteristic values of the induced voltage uₑₘₖ, for example. With known magnetic properties of the drive magnets 4 of the respective transport unit Tn, it is also possible to infer the air gap 9 of the respective transport unit Tn (for example width of the air gap 9 etc.) from said characteristic curve.

Furthermore, if it is assumed that the air gap 9 between the transport unit Tn and the surface of the transport track 2 remains constant in a specified observation period, temperature changes in the area of the inducing drive magnets 4 on the transport unit Tn can be inferred using the method according to the present disclosure. For this purpose, for example, a short observation period (for example one day or a few days, etc.), during which a profile of the manipulated variable SG or the induced voltage uₑₘₖ is captured repeatedly, is selected.

For wear observation (for example wear of guide elements on transport units Tn etc.), a longer observation period, such as a duration of one or more months, etc., during which the profile of the manipulated variable SG or the induced voltage uₑₘₖ is repeatedly determined, can be defined, for example. The normal force and/or the air gap 9, for example, can then be derived therefrom and recorded. The recording of the profile of the manipulated variable SG in the respective observation period can be repeated, for example, continuously or cyclically at specified intervals (for example daily, weekly, etc.).

The method according to the present disclosure for monitoring the operation of a transport device 1 can thus be carried out repeatedly in a transport device 1 during operation, for example, for selected transport units Tn during a specified observation period (for example several days or several months). I.e., the profile of the manipulated variable SG or the induced voltage uₑₘₖ is captured at at least one selected measurement coil M for the selected transport units Tn and from this, for example, a profile of the respective normal force, with which the drive magnets 4 of the respective transport unit Tn act on the surface of the transport track 2, is determined. Wear of the guide elements of the respective transport unit Tn can be inferred, for example, from the changes in the determined profiles. A temperature of the drive magnets 4 can also be inferred, for example, from the change in the normal force.

A time profile of the magnetic flux y can be derived from the time profile of the manipulated variable SG, as shown by way of example in FIG. 5a, as a function of a position P of the transport unit Tn while traveling over the measurement coil M, for example by integration. Such a profile is shown as example in FIG. 5b. The x-axis again shows the position P of the transport unit Tn in meters over the selected measuring coil M. A corresponding value of the magnetic flux y is plotted on the y-axis. Depending on the position P of the transport unit Tn and the interaction of one or more drive magnets 4 with the measurement coil M and as a function of the respective polarity of the acting drive magnets 4, extreme values (minima, maxima) and zero crossings are produced in the time profile of the magnetic flux w. If these extreme values (level, location, aptitude, etc.) are evaluated, conclusions can be drawn about the material used for the drive magnets 4, the attachment thereof (for example adhesive bonding etc.), etc. Extreme values, such as the amplitude of the negative maximum, which correspond, for example, to the polarity of the drive magnets 4, amplitudes of the boundary maxima, which correspond, for example, to the effect of respective boundary drive magnets, etc., are compared with expected values. Furthermore, spacings between the extreme values in the profile of the magnetic flux y can also be evaluated and compared with corresponding expected values. In this way, for example, it is possible to identify errors in the attachment of the drive magnets 4 on the transport unit Tn—such as magnet detachments, displacement of magnets 4, distortions in the direction of polarity, etc. Furthermore, it is also possible to select transport units Tn for running operation of the transport device 1 based on the evaluation of the extreme values of the time profile of the magnetic flux v.

The method for monitoring a transport device 1 using the associated apparatus also provides the option to check settings of transport segments TSk of the transport track 2, in particular, the setting of the transport segments TSk in the guide system. To this end, for example, first of all at least one drive coil 3 can be selected as the measurement coil M in each transport segment TSk that is to be checked. A defined transport unit Tn is then positioned on the transport device 1 or on the transport track 2, the time profile of the manipulated variable SG or the normal force of said transport unit Tn being known, for example. The transport unit Tn is then moved over the transport track 2 or over the transport segments TSk that are to be checked and in the process the time profile of the manipulated variable SG is captured and, for example, the normal force is derived accordingly. This process is repeated for each further drive coil 3 of the respective transport segment TSk that is to be checked—i.e., each drive coil 3 of the transport segment TSk that is to be checked functions as the measurement coil M at least for one measurement cycle of the manipulated variable SG. An overview of, for example, the normal force and/or air gap 9 of the respective checked transport segment TSk of the transport track 2 is obtained through subsequent evaluation of the captured time profiles of the manipulated variable SG for the drive coils 3 of the respective transport segment TSk that is to be checked. As a result, for example, poorly or erroneously installed transport segments TSk, drive coils 3, etc. can be identified and corrected.

1. A method for monitoring the operation of a transport device in the form of a long stator linear motor having a transport track along which a plurality of drive coils are arranged,
wherein at least one transport unit is moved along the transport track, wherein drive magnets of the transport unit interact with the drive coils of the transport track to produce a propulsive force, and
wherein at least one drive coil of the transport track is selected as a measurement coil, in that, while the at least one transport unit is moving over the measurement coil, a manipulated variable is predetermined as an excitation signal in a such way that a respective present coil current in the measurement coil is controlled to a predetermined setpoint value, in that a time profile of the manipulated variable is captured, while the at least one transport unit is being moved over the measurement coil, and in that the captured time profile of the manipulated variable is evaluated to monitor the transport device.

2. The method of claim 1, wherein a value of zero is specified as the setpoint value.

3. The method of claim 1, wherein a drive controller, which is assigned to the drive coil that is selected as the measurement coil, is used for predetermining the manipulated variable as the excitation signal.

4. The method of claim 1, wherein in the case of a transport track with at least two transport segments, at least one drive coil is selected as the measurement coil in each transport segment.

5. The method of claim 1, wherein the at least one drive coil of the transport track is selected as the measurement coil for a limited time, in particular for a duration of one measurement cycle.

6. The method of claim 1, wherein the at least one drive coil of the transport track is selected as the measurement coil permanently.

7. The method of claim 1, wherein an observation period, in which the time profile of the manipulated variable is captured, is specified.

8. The method of claim 1, wherein the time profile of the manipulated variable is captured at cyclically repeating intervals.

9. The method of claim 1, wherein a time profile of a magnetic flux is derived from the captured time profile of the manipulated variable for evaluation.

10. The method of claim 1, wherein the captured time profile of the manipulated variable is normalized to a nominal speed of the at least one transport unit.

11. An apparatus for monitoring the operation of a transport device in the form of a long stator linear motor having a transport track along which a plurality of drive coils are arranged, and having at least one transport unit which is able to be moved along the transport track,
wherein drive magnets of the transport unit interact with the drive coils of the transport track to produce a propulsive force, and
wherein the apparatus at least comprises:
a measurement coil being selected from the plurality of drive coils arranged along the transport track;
a control unit which is configured to predetermine a manipulated variable as an excitation signal to the measurement coil in such a way that the respective present coil current is controlled to a specified setpoint value;
a unit configured to capture a time profile of the manipulated variable; and
an evaluation unit configured to evaluate the time profile of the manipulated variable.

12. The apparatus of claim 11, wherein a drive controller, which is assigned to the drive coil that is selected as the measurement coil, is used as the control unit.

13. The apparatus of claim 11, wherein the unit that is configured to capture the time profile of the manipulated variable is integrated into the control unit.

14. The apparatus of claim 11, wherein the evaluation unit that is configured to evaluate the time profile of the manipulated variable is configured to derive a time profile of a magnetic flux from the captured profile of the manipulated variable.
